(19) United States
(12) Patent Application Publication
(10) Pub. No.: US 2007/0005593 A1
(43) Pub. Date: Jan. 4, 2007

(54) Attribute-based data retrieval and association

(75) Inventors: Joseph L. Self, Redmond, WA (US); Craig T. Sinclair, Sammamish, WA (US); Gregory D. Fee, Seattle, WA (US); Marcelo Uemura, Seattle, WA (US); William Devlin, Sammamish, WA (US); Pravin Indurkar, Sammamish, WA (US); David Bozich, Enumclaw, WA (US); Tracey G. Trewin, Woodinville, WA (US); Jayesh Rege, Redmond, WA (US); Gregory A. Eisenberg, Woodinville, WA (US); Jeanine E. Spence, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/170,835

(22) Filed: Jun. 30, 2005

(51) Int. Cl. G06F 17/30

(52) U.S. Cl. 707/6

(57) ABSTRACT

In a matching system one or more related techniques use correlators to match entities and to look up metadata. Correlators are names that enable the matching system to associate entities with other entities. Attributes comprised of name/value pairs are used by the matching system to determine if two entities match. When two entities match, a process associated with an entity may be executed using the data associated with one or both of the matching entities. If the matching system is unable to determine a best match, all matching entities are provided to another process or human for further review. The matching system provides for the injection of new entities or correlators, to dynamically change the behavior of the system. Entities can be defined using a hierarchy, so that some of the entity properties are defined through an inheritance relationship with parent entities.

### BACKGROUND

Some systems manage data as well as behavior associated with that data. It is often difficult to change how such systems operate because the data and the behavior associated with the data are tightly coupled. Furthermore, in a computer system with computer-executable functions, making a change often requires modifying existing computer-executable functions and creating new computer-executable functions.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various technologies and techniques directed to a matching system that associates items comprised of name/value pairs with other items. More particularly, described herein are, among other things, systems, methods, and data structures that facilitate association of items with other items.

An item may have some associated logic, some associated data, or may have both associated logic and data. The matching system may match items to enable the use of their associated logic and/or data. One implementation of a matching system may match items and then invoke the logic associated with one or more of the matching items. For example and without limitation, when an item is presented to the system, logic associated with a matching item or items may be executed. Another or the same implementation of a matching system may use the data associated with matching items. For example and without limitation, if an item is sent from the system, the data associated with a matching item or items may be used to determine where or how to send the item.

The matching system may use correlators and attributes. Correlators are fields that may characterize data matched by a particular item and that may be used, with attributes, when matching an item against a set of other items. Attributes made up of name/value pairs may comprise the values used to determine if an item matches another item.

Among other functionality, the matching system provides for the injection of new items or the modification of the logic or data associated with existing items. Because items may have logic, data, or both logic and data, this ability may be used to dynamically change the data in the system and/or the behavior of the system. The matching system also enables a human or other process to evaluate multiple matching items in some cases, for example when the matching system is unable to choose between multiple matching items.

### DESCRIPTION OF THE DRAWINGS

FIG. 1 is an illustration of an exemplary computing device in which the various technologies described herein may be implemented.

FIG. 2 is an illustration of an exemplary system in which attribute-based data retrieval and matching may be carried out.

FIG. 3 is a generalized representation of an entity.

FIG. 4 is an illustration of an exemplary operational flow that includes various operations that may be performed when attempting to match an incoming item to a particular entity.

FIG. 5 is an illustration of an exemplary operational flow that includes various operations that may be performed to determine which entity or entities, if any, a specific item matches.

FIG. 6 is an illustration of an exemplary operational flow that includes various operations that may be performed to determine if a particular entity and correlator match a particular item to match.

FIG. 7 is an illustration of an exemplary operational flow that includes various operations that may be performed when attempting to find a specific name/value pair or set of name/value pairs given a particular item to match.

FIG. 8 is a diagram of a number of exemplary entities.

### DETAILED DESCRIPTION

Described herein are various technologies and techniques directed to a matching system that associates items comprised of name/value pairs with other items. More particularly, described herein are, among other things, systems, methods, and data structures that facilitate association of items with other items.

Included in the various technologies and techniques described herein is a unique matching module that associates an item comprising a set of name/value pairs and, in some implementations, other data, with one or more entities that match the item, where the entities may also include a set of name/value pairs and other data. The matching module may use “correlators,” which are fields that characterize the data matched by a particular entity and that are used when matching the item against a set of entities in an entity store. Both “item” and “entity” are defined in more detail below.

In one or more implementations, the matching module uses a “holding pond” to enable a human or other process to decide between multiple matches, when a best match cannot be determined by the matching module. In one or more implementations, the overall operation of the matching system can be changed dynamically by modifying, adding to, or removing the entities in the entity store.

As used herein, entities may have various forms and formats. For example, in at least one implementation, an entity may be implemented using a set of rows in a database that comprise some number of name/value pairs (“attributes” or “properties”), some number of correlators that characterize the data matched by the entity, and some other data. In some implementations, an entity may also contain a reference to some logic or executable task associated with the entity. This logic may, in some cases, be executed by the matching system, by an application that receives a matching entity, or by some other process. In one or more implementations, the logic may use data associated with the entity or matching item.

In addition to being used to match entities, in at least one implementation, the matching module can also be used to find name/value pairs across related entities by first finding one or more matching entities, and then by performing a similar matching process on these matching entities, until the desired data is found or all matches are exhausted.

Example Computing Environment

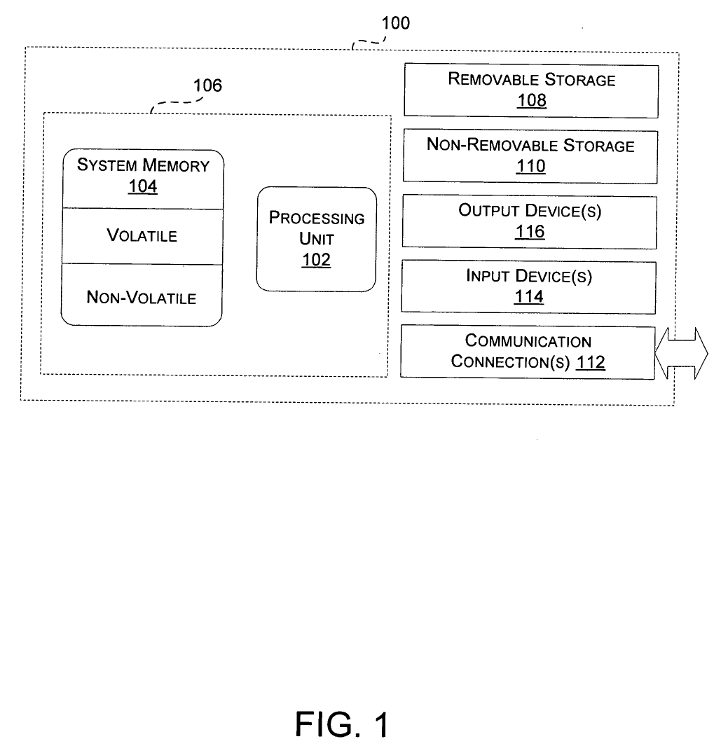

FIG. 1 and the related discussion are intended to provide a brief, general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 100 illustrated in FIG. 1.

Generally, program modules include routines, programs, objects, components, data structures, etc., that perform particular tasks or implement particular abstract data types. Tasks performed by the program modules are described below with the aid of block diagrams and operational flowcharts.

Those skilled in the art can implement the description, block diagrams, and flowcharts in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

Turning now to FIG. 1, in its most basic configuration, the computing device 100 includes at least one processing unit 102 and memory 104. Depending on the exact configuration and type of computing device, the memory 104 may be volatile (such as RAM), non-volatile (such as ROM, flash memory, etc.), or some combination of the two. This most basic configuration is illustrated in FIG. 1 by dashed line 106. Additionally, the computing device 100 may also have additional features/functionality. For example, the computing device 100 may also include additional storage (removable and/or non-removable) including, but not limited to, magnetic or optical disks or tape. Such additional storage is illustrated in FIG. 1 by the removable storage 108 and the non-removable storage 110.

The computing device 100 may also contain one or more communications connection(s) 112 that allow the computing device 100 to communicate with other devices. The computing device 100 may also have one or more input device(s) 114 such as keyboard, mouse, pen, voice input device, touch input device, etc. One or more output device(s) 116 such as a display, speakers, printer, etc. may also be included in the computing device 100.

Those skilled in the art will appreciate that the technologies described herein may be practiced with computing devices other than the computing device 100 illustrated in FIG. 1. For example, and without limitation, the technologies described herein may likewise be practiced in hand-held devices, multiprocessor systems, microprocessor-based or programmable consumer electronics, network PCs, minicomputers, mainframe computers, and the like.

The technologies described herein may also be implemented in distributed computing environments where tasks are performed by remote processing devices that are linked through a communications network. In a distributed computing environment, program modules may be located in both local and remote memory storage devices.

While described herein as being implemented in software, it will be appreciated that the technologies described herein may alternatively be implemented all or in part as hardware, firmware, or various combinations of software, hardware, and/or firmware.

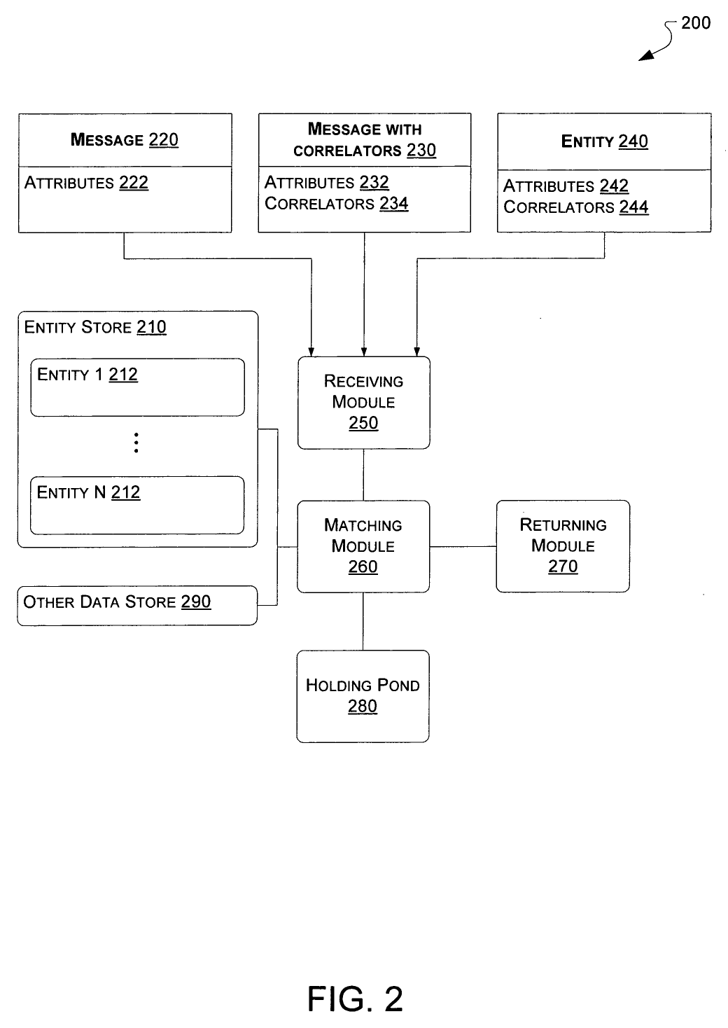

Turning now to FIG. 2, shown therein is a system 200 in which attribute-based data retrieval and matching may be carried out. Included in the system 200 are an entity store 210, an other data store 290, a receiving module 250, a matching module 260, a returning module 270, and a holding pond 280. In some implementations, the receiving module may receive, interalia, zero or more messages 220, zero or more messages with correlators 230, and zero or more entities 240.

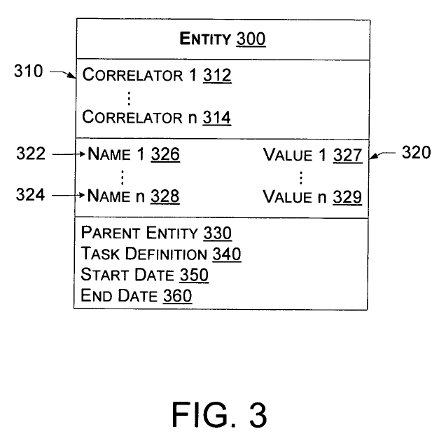

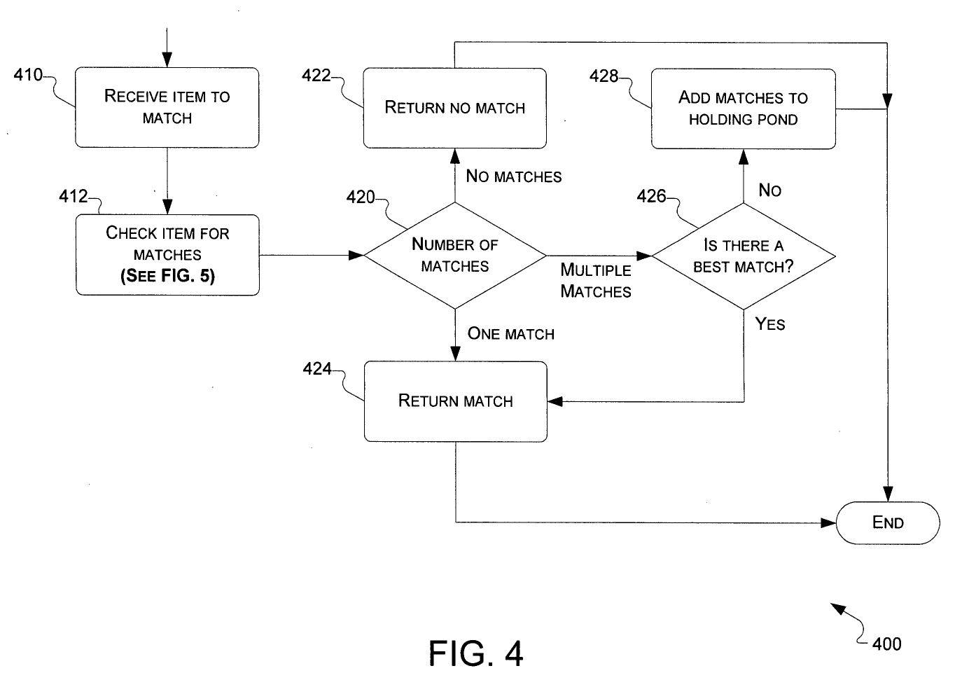

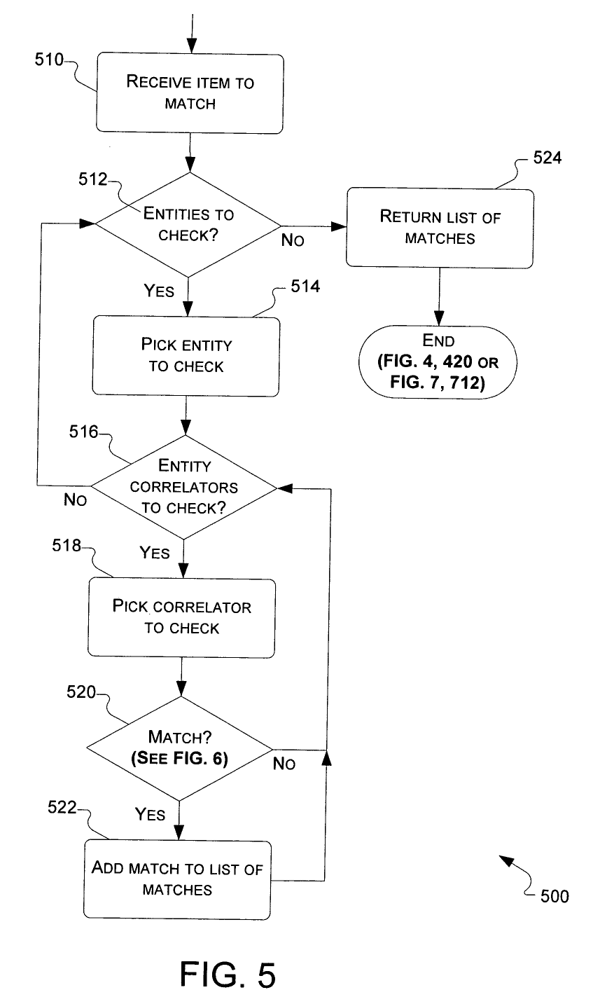

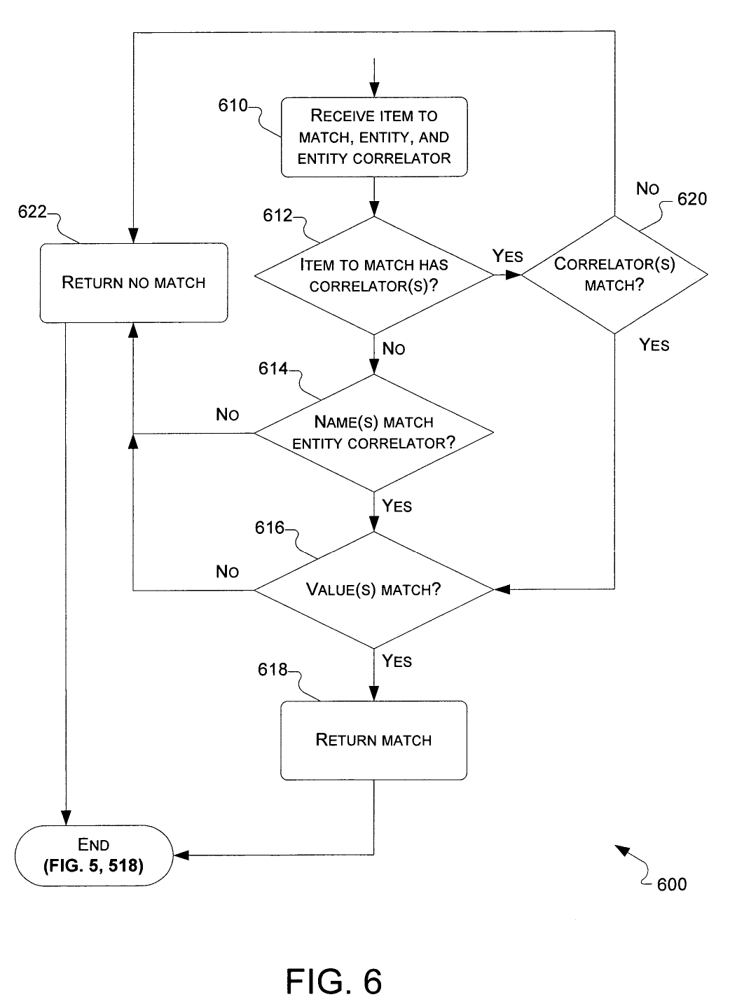

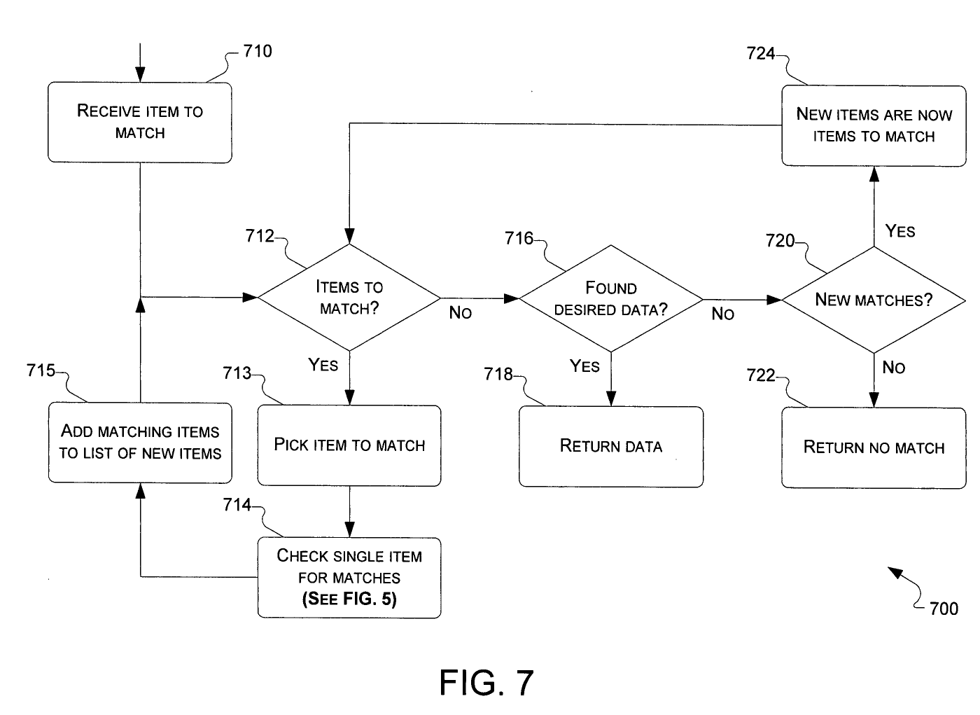

The following description of FIG. 2 is made with reference to the data structure 300 of FIG. 3 and the operational flows 400 (FIG. 4), 500 (FIG. 5), 600 (FIG. 6), and 700 (FIG. 7). However, it should be understood that the system described with respect to FIG. 2 is not intended to be limited to being used by, or interacting with, elements of the data structure 200 or the operational flows 400, 500, 600, or 700.

During each matching attempt, the receiving module 250 of the matching system 200 accepts a message 220, a message with correlators 230, or an entity 240. As used herein, the term “item” refers to a data structure that contains one or more name/value pairs. The term “attribute” refers to a name/value pair associated with an item. A message 220 contains a set of attributes 222. A message with correlators 230 contains a set of attributes 232 and correlators 234. And an entity 240 contains a set of attributes 242 and correlators 244. Each attribute comprises a name/value pair, and so a message 220, a message with correlators 230, and an entity 240, can all accurately be referred to as an “item”. The nature of attributes, correlators, and entities is described in more detail below, with reference especially to FIG. 3.

The item accepted by the receiving module 250 represents the item to match. That is, it represents the item that contains the data, expressed in attributes, for which the matching module 260 attempts to find matches. In some implementations, a calling application provides the item to match to the receiving module 250. After the item to match is received, the receiving module passes the item to match to the matching module 260.

The matching module 260 attempts to find entities that match the item to match. In some implementations, the matching module does this by comparing the item to match to the entities maintained in the entity store 210. Each entity 212 associated with the entity store 210 is an entity of the type described with reference to FIG. 3. In other implementations, the matching module also uses data from the other data store 290. The details of the matching process performed by the matching module 260 are described herein with reference to FIG. 4, FIG. 5, FIG. 6, and FIG. 7.

The result of the operations executed by the matching module 260 is, in at least one implementation and in one or more cases, returned to the calling application using the returning module 270. For example, and without limitation, in the case where a calling application provides an item to match and the matching module 260 finds an entity that matches the item to match, the matching system may return the matching entity to the calling application using the returning module 270.

In one or more other implementations and in one or more cases, when the matching module 260 finds multiple entities that match an item to match and, for example and without limitation, the matching module 260 cannot determine which entity to return (i.e. the matching module 260 cannot determine a single, best match), the matching module 260 may place all of the matching entities in a holding pond 280. In another implementation, the matching module may place the original item to match in the holding pond. The calling application, another application or process, or a human user, can then review the multiple matching entities or the ambiguous item to match and take further action. This further action may include manually selecting an entity, providing additional matching rules or entities so that the matching module can determine a single match, modifying the ambiguous item to match so that it is no longer ambiguous—that is, so it matches when presented again to the matching system, or some other action.

In an alternative implementation, rather than using a holding pond to aid in disambiguating multiple matches, the matching module 260 might just return all matches. This might be useful, for example, to implement a “notification” system where multiple entities might be interested in responding or being notified when particular items to match are presented to the matching system. In the same or another implementation, the item to match might indicate if it can be matched to multiple entities or if any case of multiple matches should be handled by a holding pond or other similar element. Similarly, in the same or other implementations, an entity might indicate if it can be part of a multiple match, or if it must be the only matching entity.

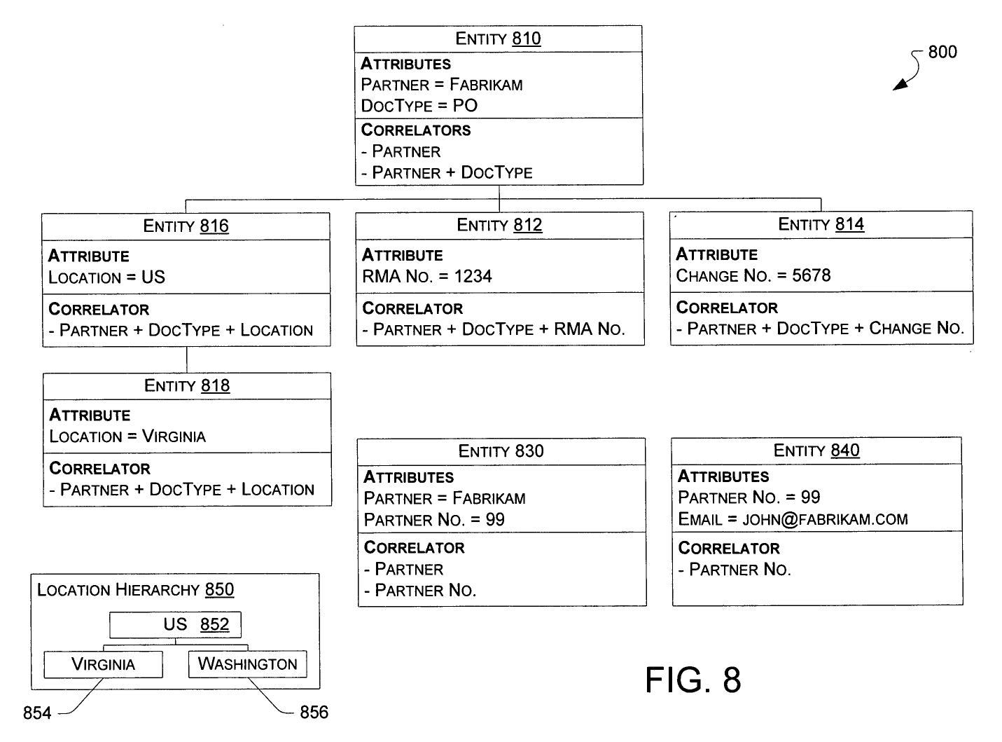

Turning now to FIG. 3, illustrated therein is a generalized representation of an entity 300. The following description of FIG. 3 is made with reference to the system 200 of FIG. 2 and the example entities of FIG. 8. However, it should be understood that the entity described with respect to FIG. 3 is not intended to be limited to being used by, or interacting with, elements of the system 200 or the example entities of FIG. 8.

In general, an entity 300 represents some data used by the matching system 200. The data comprises, but is not limited to, correlators 310, attributes 320, a parent entity reference 330, a task definition 340, a start date 350 and an end date 360. An entity 300 may be matched against, or may comprise the data being matched. The matching system 200 matches incoming items, which include messages and entities, against the set of entities maintained by the matching system.

An entity 300 may be implemented as an object in an object-oriented environment and embodied in a computer-readable medium, or in multiple computer-readable media. However, it should be understood that the functionality described herein with respect to an entity can also be implemented in a non-object-oriented fashion, and can be implemented on many types of systems, both object-oriented and non-object-oriented. Furthermore, an entity can be stored using a variety of storage media, including, without limitation, a database or databases or a file or files.

As shown, the correlators 310 include correlator 1 312 through correlator n 314 and the attributes 320 include attribute 322 through attribute 324. Each correlator may contain one or more names that characterize the data matched by the entity. Each attribute 322, 324 further comprises a name/value pair. For example, attribute 322 includes a name 1 326 and a value 1 327 and attribute 324 includes a name n 328 and a value n 329. In this particular example, as previously stated, the entity also includes parent entity field 330, task definition field 340, start date field 350, and end date field 360.

Each correlator 312 contains one or more names that “characterize” the data that the entity on which the correlator is defined may match. In one or more implementations, this “characterization” may be implemented by having a correlator name specify one or more attribute names. By using the correlator to specify one or more attribute names, the entity indicates that it may match items that have attributes with those attribute names. For example, entity 810 of FIG. 8 contains two correlators: one that matches an attribute name of “Partner”, and one that matches attribute names of “Partner” and “DocType” together. Because of these correlators, entity 810 may match items that have a “Partner” attribute, and may match items that have a “Partner” attribute and a “DocType” attribute. Note that a correlator may only specify the name of an attribute that an item must have to match the particular entity. That is, a correlator may not specify a value and so may not be used, by itself, to determine if an item is a match for the entity on which a correlator is defined. For example, the “Partner” correlator does not specify a value, such as “Fabrikam”—it only specifies that the “Partner” name is relevant for matching.

The attributes 320 of an entity 300 specify information that describes the entity 300. As previously noted, each attribute 322, 324 comprises a name 326, 328 and a value 327, 329. For example, entity 810 of FIG. 8 contains two attributes: “Partner=Fabrikam” and “DocType=PO”. The first of these attributes contains a name “Partner” and a corresponding value “Fabrikam”. The second of these attributes contains a name “DocType” and a corresponding value “PO”. Note that the value of an attribute can be any piece of data. This data can be a short text string, as is illustrated with this example; an entire XML document, or any other data.

In one or more implementations, attributes 320 are first used in the matching process to determine if an entity 300 may match an item to match, by comparing an attribute name 326, 328 to a correlator 310. In one or more implementations, if the correlator and attribute names match, then, to determine if an entity actually matches an item to match, an attribute value of the item to match is compared to an attribute value 327, 329 of a particular entity.

In one or more other implementations, matching may be performed without the use of correlators. For example, and without limitation, the attributes of an item to match may be compared directly to the attributes of an entity to determine if the item to match matches the entity.

The parent entity field 330 may specify another entity (not shown) that is considered the “parent” of this entity. The entity 300 that contains the reference to the parent entity is then considered a “child” entity. Using this parent/child relationship, child entities may inherit attributes or, in some cases, other data defined on parent entities. For example, entity 812 of FIG. 8 is a child entity of entity 810. In one or more implementations, the parent entity field of entity 812 contains a reference to entity 810. Because of this relationship, in some implementations, entity 812 inherits the “Partner=Fabrikam” and “DocType=PO” attributes from entity 810. Entity 812 also defines a new attribute “RMA No.=1234”. Note that, in terms of the attributes that define it, entity 812 could also have been defined in an alternative implementation with an empty or null value for the parent entity field, and to contain the same “Partner=Fabrikam” and “DocType=PO” attributes. In both cases, the entity is considered to contain the same set of three attributes. Not all implementations may use entity inheritance, and implementations that do not use entity inheritance may have no need for this field. Furthermore, other implementations may use other mechanisms that provide the same or similar functionality by eliminating or lessening the need to define the same or similar attributes on multiple entities.

The task definition field 340 specifies a task or process that may be executed or used in association with a match. For example, entity 812 of FIG. 8, which includes a correlator and an attribute for “RMA No.”, where “RMA” is an acronym for “Return Material Authorization,” may have a task definition that specifies a set of instructions that relate to returning material. These instructions could include, for example, and without limitation, updating one or more enterprise resource management databases, sending emails, and so on. In the present example, when an item matches entity 812, the process identified in the task definition field may be executed to update databases, and so on, using the data provided in the item to match and the entity.

Not all implementations may have a task definition field 340. For those implementations that do include a task definition field, the value of the field may be any type of data that specifies or references a task or process. For example, the value could be an XML string that contains XML data that can be interpreted to execute a task. In other implementations, for example and without limitation, the value could be a Java, NET, or Component Object Model (COM) type identifier that identifies an object that implements a task, or could contain the actual binary data that comprises a programmatic entity like a java, .NET, or COM object. The value of the task definition field may be empty or null, if no task is associated with the entity.

The start date field 350 and end date field 360 may specify a date range during which the entity is meant to be used. For example, an entity with a start date field of “1/1/2005” and an end date field of “6/30/2005” could be a valid match for any use during this date range. Note that the nature of the use of these fields, if they exist in a particular implementation, may be dependent on the application using the entity, and on the matching system. For example, a particular application may use these fields to determine which entity to match when processing a message submitted on a certain date, another application may use these fields to determine which entity to match when processing a message last saved on a particular date, and so on. Furthermore, some applications may not use these fields. Finally, some implementations may not contain these fields.

Turning now to FIG. 4, shown therein is an exemplary generalized operational flow 400 including various operations that may be performed when attempting to match an incoming item to a particular entity. Again, an “item” is any data structure that contains one or more name/value pairs as used herein. One example of an item is an entity, such as entity 300 described in FIG. 3. Two other examples of an item are the message 220 or message with correlators 230 of FIG. 2. In one implementation, where the operational flow 400 is used as part of a business process workflow application, the purpose of the operational flow may be to match an incoming message that contains information about, for example and without limitation, a particular customer and type of order, with a business process that specifies a task to be performed using the data contained by the message. In this specific case, the incoming message is the item to be matched and the set of business processes are the entities against which the item is matched. In this example, the operational flow 400 attempts to find the best possible match for the incoming message among the business processes maintained by the system.

This description of FIG. 4 is made with reference to the exemplary system 200 of FIG. 2, the exemplary data structure 300 of FIG. 3, the exemplary operational flows 500 of FIG. 5 and 600 of FIG. 6, and the exemplary entities of FIG. 8. However, it should be understood that the exemplary operational flow 400 described with respect to FIG. 4 is not intended to be limited to being associated with the exemplary system 200, the exemplary data structure 300, the exemplary entities of FIG. 8, or the exemplary operational flows 500 or 600.

Additionally, it should be understood that while the exemplary operational flow 400 indicates a particular order of operation execution, in one or more alternative implementations the operations may be ordered differently. Furthermore, while the exemplary operational flow contains multiple discrete steps, it should be recognized that in some environments some of these operations may be combined and executed contemporaneously.

As shown, in one implementation of operation 410, the receiving module 250 receives an item to be matched. For example, and without limitation, suppose that this item is a message 220 that contains two attributes: “Partner=Fabrikam” and “DocType=PO”. Further, for this example and again without limitation, suppose the entity store 210 contains the example entities illustrated in FIG. 8. Note that the steps executed as part of the exemplary operational flow 400 change depending on the nature of the incoming item to be matched and depending on the entities in the entity store. Further examples below demonstrate some other functionality of the exemplary operational flow 400.

In one implementation of operation 412, the matching module 260 determines if the item to match matches any of the entities in the entity store 210. Operation 412 may determine that there are no entities that match the item to match, that a single entity matches the item to match, or that multiple entities match the item to match. In one implementation, the specific operations taken to perform the matching operation are discussed below with reference to FIG. 5. In other implementations, the specific operations may be different than those discussed with reference to FIG. 5.

Continuing the example introduced in the discussion of operation 410 above, and without limitation, operation 412 determines that the item to match matches a single entity, entity 810. Operation 412 may select this entity because the entity has at least one correlator that contains names specified in the message, and the values associated with these names are the same in the entity and the message. Specifically, the entity 810 has a “Partner” correlator and a “Partner+DocType” correlator, and the message has attributes with the names “Partner” and “DocType”. The fact that the entity has an attribute named “Partner” satisfies the “Partner” correlator, and the fact that the entity has attributes named “Partner” and “DocType” satisfies the “Partner+DocType” correlator.

However, simply having an attribute of the same name as a correlator is not sufficient to make a match—the values associated with the names must also match. This is the case with entity 810, as the entity attribute named “Partner” contains the value “Fabrikam” and the entity attribute named “DocType” contains the value “PO”. Both of these values match the values in the item to match.

The previous text explains why entity 810 is selected as a match. It is also important to note that none of the other entities illustrated in FIG. 8 are selected because all of the other entities contain correlators that cannot be satisfied by the attribute data present in the item to match. For example, entity 812 has a “Partner+DocType+RMA No.” correlator. The item to match has no “RMA No.” attribute, so it cannot match entity 812. The same applies to the other remaining entities illustrated in FIG. 8. Again, for details of the matching process used in this example, but without limitation, see the discussion below for FIG. 5.

When the entity store 210 has been examined for matches, the operational flow 400 proceeds to operation 420. If it is determined in operation 420 that that no entities matched the item to match (“No Matches” branch, operation 420), the operational flow 400 continues to operation 422, described below. If it is determined in operation 420 that multiple entities matched the item to match (“Multiple Matches” branch, operation 420), the operational flow 400 continues to operation 426, also described below. Finally, if it is determined in operation 420 that a single entity matched the item to match (“One Match” branch, operation 420), the operational flow 400 continues to operation 424.

If a single entity matched the item to match (“One Match” branch, operation 420), the operational flow proceeds to operation 424, where the returning module 270 returns the single entity that matched the item to match. The operational flow 400 attempts to find the best match for the provided item to match. In the case where there is only a single matching entity, the single matching entity is the best match, and so the operational flow returns the single matching entity. An application that initiated operational flow 400 by providing the item to match can now take whatever action is appropriate using the data in the matching entity. For example, in a business process workflow system, the entity may represent a business process and may contain instructions that the application now executes. In one or more implementations, these instructions may be referenced by the task definition field 340. In one or more other implementations, the application may use the matching item for some other purpose.

If operation 420 determines that no entities matched the item to match (“No Matches” branch, operation 420), the operational flow 400 proceeds to operation 422. In at least one implementation of operation 422, the returning module 270 returns data indicating that no entities matched the provided item to match. An application that initiated operational flow 400 can then take appropriate action. For example, and without limitation, an application might log that no entities were found, it might notify a user, or it might perform some other operation.

In some implementations, an entity or entities may be defined in such a way so as to match any item to match that is not matched by another entity in the entity store. In such implementations, operation 420 may never proceed to operation 422, because there will always be at least one match.

If operation 420 determines that multiple entities matched the item to match (“Multiple Matches” branch, operation 420), the operational flow proceeds to operation 426. In at least one implementation of operation 426, the matching module 260 determines if one of the matching entities is a “best match” for the item to match. If a best match is found (“Yes” branch, operation 426), the operational flow 400 proceeds to operation 424, where the best matching entity is returned in the same manner as if a single matching entity had been found. If a best match cannot be found (“No” branch, operation 426), the operational flow 400 proceeds to operation 428.

Generally, the matching module 260 attempts to find a best match by using the data contained in the entity store 210 and the other data store 290 to infer if one matching entity contains, for example, more specific data than another matching entity. If one of the matches is a more specific match, it may then be considered a “best match.”

The matching module may use a variety of inputs to determine if the data contained by a matching entity is more specific then the data contained by another matching entity. These inputs include, but are not limited to, attribute hierarchy data like that shown in the example location hierarchy 850 or the start date field 350 and/or end date field 360.

One of the inputs that the matching module 260 may use to disambiguate multiple matching entities are, in some implementations, attribute values that are defined using a hierarchy, in contrast to attributes defined at a single level. An example of an attribute defined at a single level might be an attribute named “Color”. A value for this attribute might be, for example, “Red” or “Blue”. While the attribute can contain a variety of values, none of the values may be more specific or more general than any other. For example, “Red” is not more specific or more general than “Blue”.

In contrast, an attribute value defined using a hierarchy can sometimes be considered more specific or more general than another attribute value, depending on its location in a hierarchy of values. One example of a hierarchy of values might be for an attribute called “Location”. The example location hierarchy 850 shows such a hierarchy. In this example, a “Location” attribute might contain the values “US” 852, “Virginia” 854, or “Washington” 856. In this example, a value of “Virginia” 854 or “Washington” 856 is considered more specific than a value of “US” 852.

As a more detailed example of how a best match might be found using the example entities illustrated in FIG. 8, consider an item to match that contains the attributes “Partner=Fabrikam”, “DocType=PO”, and “Location=Virginia”. When processed by the operational flow 400, this item may be found to match both entity 816 and entity 818. The correlators on entity 816 and entity 818 both contain the names in the item to match, so the values associated with the entities are compared to the values in the item to match. For entity 816, the value “US” matches the item to match's value of “Virginia”, because “US” is a more general case of the value “Virginia”. Entity 818 also matches the item to match, because both entity 818 and the item to match contain the exact value of “Virginia”. In this example, operation 426 can find that entity 818 is a best match, because it can determine that entity 818 is a more specific match than entity 816.

Another method for determining if a particular entity is a better match may use the start date field 350 and the end date field 360. When using these fields, an entity that has a smaller date range may be considered a more specific, and therefore, better, match than an entity with a larger date range. For example, all other attribute values being the same, an entity with a start date of “6/1/2005” and an end date of “6/30/2005”—a date range of one month—might be considered a better match than an entity with a start date of “1/1/2005” and an end date of “12/31/2005”—a date range of an entire year.

There are a number of methods for determining if a particular entity is a better match than another entity, of which the previous paragraphs have shown just two examples. Operation 426 may use either of these exemplary methods, or another method, to determine if a particular entity is a better match than another entity.

If a single best match cannot be found (“No” branch, operation 426), the operational flow 400 proceeds to operation 428. In one implementation of operation 428, the multiple matches are added to a holding pond 280. As used herein, a holding pond 280 is a data structure that maintains references to multiple entities for further review by, for example and without limitation, a human or another computer-executable function.

For a more detailed example of when the holding pond 280 might be used with the example entities in FIG. 8, consider an item to match that contains the attributes “Partner=Fabrikam”, “DocType=PO”, “RMA No.=1234”, and “Change No.=5678”. When processed by the operation flow 400, this item is found to match both entity 812 and entity 814. The correlator on entity 812 contains the attributes named “Partner”, “DocType”, and “RMA No.”, all of which are defined on the item to match. Furthermore, the values for these attributes also match, so entity 812 matches the item to match. As for entity 814, the correlator contains the attributes named “Partner”, “DocType”, and “Change No.”, and these attributes also are a part of the item to match, and contain the same values. Therefore, entity 814 also matches the item to match.

Because two entities match, operational flow 400 proceeds to operation 426, which attempts to determine the best match. In this example, with these entities, there is no way for operation 426 to determine which entity is a better match. Therefore, the operational flow 400 proceeds to operation 428, and both matches are added to the holding pond 280. In this example, it is now up to a human or some other computer-executable function or process to evaluate the matches and determine which match should be used for further processing. In the case where a human user does this evaluation, the user may use an application that displays information about the entities and enables the user to choose one of the entities.

Rather than explicitly choosing a particular entity, another option, among many, for resolving the case where multiple entities match is to define a new entity that is a better match than any other entity, and then to let the operational flow 400 execute again. For example, a user could define a new entity that contains the correlator “Partner+DocType+RMA No.+Change No.” and values that match the values on the item to match. Then, when the same item to match is put back through operational flow 400, this new entity is considered a better match than any other entity, and the holding pond is not be used.

Finally, as discussed above with reference to FIG. 2, in an alternative implementation, rather than using a holding pond to aid in disambiguating multiple matches, the operational flow 400 might just return all matches for a particular item to match.

Turning now to FIG. 5, shown therein is an exemplary generalized operational flow 500 including various operations that may be performed to determine which entity or entities, if any, a specific incoming item matches. In particular, the operational flow 500 illustrates operations that may be performed by a matching module 260 to carry out the check item for matches operation 412 of operational flow 400 or the check single item for matches operation 714 of operational flow 700.

The description of FIG. 5 is made with reference to the exemplary system 200 of FIG. 2, the exemplary operational flows 400 of FIG. 4 and 600 of FIG. 6, and the exemplary entities of FIG. 8. However, it should be understood that the exemplary operational flow 500 described with respect to FIG. 5 is not intended to be limited to being associated with the exemplary system 200, the exemplary operational flows 400 or 600, or the exemplary entities of FIG. 8. Additionally, it should be understood that while the operational flow 500 indicates a particular order of operation execution, in other implementations the operations may be ordered differently. Furthermore, while the operational flow contains multiple discrete steps, it should be recognized that in some environments some of these operations may be combined and executed at the same time. For example, in some implementations, the entity store may be implemented using, in part, a SQL database, and the process of finding zero or more matching entities may be accomplished, in part or in whole, by executing some number of SQL statements.

As shown, in one implementation of operation 510, the matching module 260 receives an item to be matched against the entities in the entity store 210. To illustrate one path through operational flow 500, for example, and without limitation, suppose again that this item is a message 220 that contains two attributes: “Partner=Fabrikam” and “DocType=PO”. Further, for this example and again without limitation, suppose the entity store 210 contains the example entities illustrated in FIG. 8.

In one implementation of operation 512, the matching module 260 examines the entity store 210 and determines if any entities in the store have not yet been checked to see if they match the item to match. If all entities have been examined (“No” branch, operation 512), the operational flow 500 proceeds to operation 524, described below. If there are still entities that have not been examined for a possible match (“Yes” branch, operation 512), the operational flow 500 proceeds to operation 514, also described below.

If all entities have been checked (“No” branch, operation 512), operational flow 500 proceeds to operation 524, where, in one implementation, any matches found by operational flow 500 are returned to the operational flow that originally initiated the operational flow 500. For example, and without limitation, the list of matches may be returned to operational flow 400 of FIG. 4 or operational flow 700 of FIG. 7.

Returning to the example introduced above, the first time the operational flow 500 reaches operation 512, there are still entities to examine (no entities have been examined yet), so the operational flow 500 proceeds to operation 514.

In one implementation of operation 514, one of the entities that have not yet been checked for a possible match is chosen. In the example introduced above, the first entity chosen might be entity 810, which has two correlators: “Partner” and “Partner+DocType”, and two attributes: “Partner=Fabrikam” and “DocType=PO”. From the perspective of the operational flow 500, any entity may be chosen before any other, as long as enough entities are examined to find an appropriate match. However, the algorithm used to determine which entity to choose may be designed to meet other criteria, like speed or memory efficiency, or may be designed without regard for other criteria.

In at least one implementation of operation 516, the matching module 260 examines the entity chosen in operation 514 to determine if any correlators on the entity have not yet been checked to see if they match attributes on the item to match. If all correlators have been examined (“No” branch, operation 516), then the particular entity has also been completely checked for matches, and the operational flow 500 proceeds back to operation 512, described above. If there are still correlators that have not been examined for a possible match (“Yes” branch, operation 516), the operational flow 500 proceeds to operation 518, described below.

Continuing with the example described above, the first time the operational flow 500 reaches operation 516, the entity being checked for matches is entity 810. Neither of the correlators of entity 810 has been examined, so the operational flow proceeds to operation 518.

In one implementation of operation 518, a correlator that has not yet been examined is chosen to see if it results in a match. In the current example, suppose that the “Partner” correlator is chosen first. From the perspective of the operational flow 500, any correlator may be chosen before any other, as long as enough correlators are examined to check for appropriate matches. However, the algorithm used to determine which entity to choose may be designed to meet other criteria, like speed or memory efficiency, or may be designed without regard for other criteria.

In one implementation of operation 520, the matching module 260 determines if the entity selected in operation 514 and the correlator selected in operation 518 results in a match when compared to the item to match. The specific operations taken to determine if a match exists are discussed below with reference to FIG. 6.

Operation 520 can determine that there is a match or that there is no match. If there is not a match, the operational flow 500 proceeds back to operation 514, described above, so that correlators that have yet to be examined can be considered. If there is a match, the operational flow 500 proceeds to operation 522, described below.

In the current example, the correlator being examined is “Partner”, on entity 810. Entity 810 also has the attribute “Partner=Fabrikam”. The matching operation compares this to the item to match, which has a “Partner” attribute for which the corresponding value is “Fabrikam”. As is explained in more detail with respect to FIG. 6, this results in a match, so the operational flow 500 proceeds to operation 522.

In at least one implementation of operation 522, the match found in operation 520 is added to a list of matches that will be returned in operation 524, after all entities have been examined for matches.

While the previous example, which uses entity 810, has illustrated the operational flow 500, it is worth noting the behavior of the operational flow that results when correlators on multiple entities result in more than one matching entity. To illustrate this behavior, consider entity 810, with the correlators “Partner” and “Partner+DocType”, and entity 812, with the correlator “Partner+DocType+RMA No.”, along with an item to match that has the attributes “Partner=Fabrikam”, “DocType=PO”, and “RMA No.=1234”.

When entity 810 is examined, the operational flow 500 determines that it is a match, because both entity 810 and the item to match have attributes named “Partner” and “DocType” and the values for these attributes are the same. When entity 812 is examined, the same operational flow determines that it is also a match, because both entity 812 and the item to match have attributes for “Partner”, “DocType”, and “RMA No.” and the values for these attributes are the same. In this example, rather than returning both entity 810 and entity 812, the operational flow 500 returns only entity 812. It does not return entity 810. This occurs because the correlator on entity 812 encompasses all of the other matching correlators.

In this case, “Partner+DocType+RMA No.” encompasses both “Partner” and “Partner+DocType”. When a correlator encompasses all other matching correlators, the operational flow 500 may return only the matching entity that contains the correlator that encompasses all other matching correlators, and may not return entities that do not contain such a correlator.

Turning now to FIG. 6, shown therein is an exemplary generalized operational flow 600 including various operations that may be performed to determine if a particular entity and correlator match a particular item to match. In particular, the operational flow 600 illustrates operations that may be performed by a matching module 260 to carry out the match operation 520 of operational flow 500.

The description of FIG. 6 is made with reference to the exemplary system 200 of FIG. 2, the exemplary operational flows 500 of FIG. 5 and 700 of FIG. 7, and the exemplary entities of FIG. 8. However, it should be understood that the exemplary operational flow 600 described with respect to FIG. 6 is not intended to be limited to being associated with the exemplary system 200, the exemplary operational flow 500, or the exemplary entities of FIG. 8.

Additionally, it should be understood that while the exemplary operational flow 600 indicates a particular order of operation execution, in other implementations the operations may be ordered differently. Furthermore, while the exemplary operational flow 600 contains multiple discrete steps, it should be recognized that in some environments some of these operations may be combined and executed contemporaneously. For example, in some implementations, the entity store may be implemented using, in part, a SQL database, and the process of determining if a particular entity and correlator match a particular item to match may be accomplished, in part or in whole, by executing some number of SQL statements. In some implementations, it may be possible to perform a number of such determinations by executing even just a single SQL statement.

As shown, in one implementation of operation 610, the matching module 260 receives an item to be matched against the provided entity and specified correlator. To illustrate one path through operational flow 600, suppose that, for example and without limitation, the item to match is a message 220 that contains two attributes: “Partner=Fabrikam” and “DocType=PO”. Also suppose that the provided entity also has two attributes: “Partner=Fabrikam” and “DocType=PO”. Finally, suppose that the selected correlator on the provided entity is “Partner”.

In one implementation of operation 612, the matching module 260 examines the item to match to determine if it has its own correlators. While it is common for the item to match to be a message with attributes and without correlators, like message 220, it is also possible for the item to match to be a message with one or more correlators, like message with correlators 230, or for the item to match to be an entity in and of itself, like entity 240, and so also have its own correlators.

Depending on whether the item to match has correlators, the operational flow 600 proceeds differently. If the item to match does not have correlators (“No branch, operation 612), the operational flow proceeds to operation 614, described below. If the item to match has one or more correlators (“Yes” branch, operation 612), the operational flow proceeds to operation 620, also described below.

In the current example, the item to match is a simple message without correlators of its own (“No” branch, operation 612), so the operational flow 600 proceeds to operation 614. One example where the item to match has its own correlators is provided as part of the discussion of FIG. 7, below.

In one implementation of operation 614, the name or names described by the provided entity correlator are compared to the names of the attributes that are part of the item to match. If the item to match has attributes with the same name as each and every name specified by the correlator (“Yes” branch, operation 614), then the operational flow proceeds to operation 616, where the values are compared, and which is described below. If at least one of the names in the correlator does not exist as an attribute on the item to match (“No” branch, operation 614), this correlator cannot result in a match, and the operational flow 600 proceeds to operation 622.

In any of the cases that make a match impossible (“No” branch, operation 614), the operational flow 600 proceeds to operation 622, where, in one implementation, the failure to find a match is returned to the operational flow that originally initiated the operational flow 600. For example, and without limitation, the operational flow 600 may return to operation 520 of operational flow 500, described with reference to FIG. 5.

Returning to the example introduced above (to operation 614), the selected correlator is “Partner”, and so the item to match is examined to see if it contains an attribute named “Partner”. The item to match contains an attribute named “Partner”, so the operational flow 600 proceeds to operation 616 (“Yes” branch, operation 614).

When the operational flow 600 reaches operation 616, it is known that the name or names specified by the correlator exist as attributes on both the entity and item to match. In one implementation, the values of the names specified by the correlator are then compared. If all of the values are the same (“Yes” branch, operation 616), then the item to match matches the entity, and the operational flow 600 proceeds to operation 618. If at least one of the values does not match (“No” branch, operation 616), then the item to match does not match the entity in question, and the operational flow 600 proceeds to operation 622.

In the current example, the “Partner” attributes on both the entity and item to match contain the value “Fabrikam”, so the entity matches the item to match, and the example operational flow proceeds to operation 618.

Note that values being compared do not necessarily have to be identical in order to match. For example, if an attribute can have values defined using a hierarchy, then a more general attribute value on the entity may match a more specific value on the item to match. For example, using the example data illustrated in FIG. 8, an item to match with a “Location=Virginia” attribute may match an entity with a “Location=US” attribute, because the location hierarchy 850 shows that the value of “Virginia” 854 is a more specific instance of the value “US” 852.

Recall also that the entity attributes considered by the matching process may comprise both the attributes defined on the entity itself and, in some implementations, attributes defined on entities from which the particular entity derives.

In one implementation of operation 618, the match found by the exemplary operational flow 600 is returned to the operational flow that initiated exemplary operational flow 600. For example, and without limitation, the exemplary operational flow 600 may return to operation 520 of exemplary operational flow 500, described with reference to FIG. 5.

The remaining operation that has not been discussed yet is operation 620, which, in one implementation, handles the case where the item to match has correlators of its own. For example, this can occur when the item to match is a message with correlators 230 or when the item to match is an entity 240. In some implementations, this is a common case when executing the operational flow 700 described with respect to FIG. 7. When the item to match has correlators of its own, then operation 620 is executed as part of the operational flow 600. Operation 620 checks to see if a correlator on the item to match is the same as the entity correlator being examined as part of the operational flow.

If this is the case (“Yes” branch, operation 620), then the operational flow 600 proceeds to operation 616, described above, where the values associated with the names identified by the identical correlator are compared to determine if the entity matches the item to match. If the item to match does not contain a correlator that is the same as the entity correlator being examined (“No” branch, operation 620), then the item to match does not match the entity in question, and the operational flow 600 proceeds to operation 622.

Turning now to FIG. 7, shown therein is an exemplary generalized operational flow 700 including various operations that may be performed when attempting to find a specific name/value pair or set of name/value pairs given a particular item to match. For example, one may have a particular item to match that does not contain the desired attribute (name/value pair).

To attempt to find the desired attribute, this operational flow performs an “extension” operation, by matching the item to match against the entities in the entity store 210 and continuing to match resulting matching entities until the desired data is found or all matches have been exhausted. After the entities in the entity store have been examined for possible matches, all of the attributes from the matching entities are considered to determine if the desired name/value pair has been found.

If the desired data is not found, all of the matches found as a result of the previous matching operation are then matched against the entities in the entity store. This process continues until the desired data is found, until a specified number of matching rounds has completed, or until a matching round completes without finding any new matching entities.

As used herein, a “primary matching entity” may be an entity that directly matches the item to match. A “secondary matching entity” may be an entity that matches a primary matching entity or that matches some other secondary matching entity.

In one implementation, where the operational flow 700 is used as part of a business process workflow application, the purpose of the operational flow may be to look up metadata associated with a known piece of data or entity. For example, and without limitation, suppose that the desired data is an email address, which is known to exist in an attribute named “Email”, and that the initial item to match is a message 220 of FIG. 2, that contains the attribute “Partner=Fabrikam”.

This operational flow might attempt to find entities that match the item to match and that contain the attribute “Email”. If an initial match finds entities that match the item to match but do not contain the “Email” attribute, the operational flow might attempt to match each of the matching entities against the entity store, and then see again if any of the resulting matches contains the “Email” attribute. This might continue until at least one entity with the “Email” attribute is found, until a specified number of matching rounds has completed, or until a matching round completes without finding any new matching entities.

This description of FIG. 7 is made with reference to the exemplary system 200 of FIG. 2, the exemplary operational flows 500 of FIG. 5 and 600 of FIG. 6, and the exemplary entities of FIG. 8. However, it should be understood that the exemplary operational flow 700 described with reference to FIG. 7 is not intended to be limited to being associated with the exemplary system 200, the exemplary operational flows 500 or 600, or the exemplary entities of FIG. 8.

Additionally, it should be understood that while the exemplary operational flow 700 indicates a particular order of operation execution, in other implementations the operations may be ordered differently. Furthermore, while the exemplary operational flow 700 contains multiple discrete steps, it should be recognized that in some environments some of these operations may be combined and executed at the same time.

As shown, in one implementation of operation 710, the receiving module 250 receives an item to be matched. In one or more implementations, the receiving module 250 might also receive one or more names that represent the desired data. In one or more other implementations, the receiving module might also receive a number that specifies the maximum number of matching rounds to be executed before the operational flow completes.

To demonstrate one path through the operational flow 700, consider the example introduced above, without limitation, where the desired data is an email address, which is known to exist in an attribute named “Email”, and the initial item to match is a message 220 of FIG. 2, that contains the attribute “Partner=Fabrikam”. Further, for this example and again without limitation, suppose the entity store 210 contains the example entities illustrated in FIG. 8.

In one implementation of operation 712, the matching module 260 determines if there any items to match that have not yet been checked for matches that might exist in the entity store 210. If one or more items to match have not yet been considered (“No” branch, operation 712), the operational flow 700 proceeds to operation 713. If all items to match have been considered (“Yes” branch, operation 712), the operational flow proceeds to operation 716.

Continuing with the example introduced above, the first time the operational flow 700 reaches operation 712, there is a single item to match: the initial item provided in operation 710, with the attribute “Partner=Fabrikam”. Therefore, the example operational flow proceeds to operation 713.

In one implementation of operation 713, one of the items to match that have not yet been examined is chosen. From the perspective of the operational flow 700, any item to match may be chosen before any other, as long as all items to match are ultimately examined. However, the method that chooses an item to match may be designed to meet other criteria, like speed or memory efficiency, or may be designed without regard to other criteria. In the current example, the first time the operational flow reaches operation 713, the matching module 260 chooses the only item to match, the message 220 with the attribute “Partner=Fabrikam”.

In one implementation of operation 714, the matching module 260 determines if the item to match selected in operation 713 matches any of the entities in the entity store 210. Operation 714 may determine that there are zero or more entities that match the item to match. In at least one implementation, the specific operations taken to perform the matching operation are the same as those discussed above with reference to FIG. 5. In one or more other implementations the matching operations may be different.

Continuing with the example introduced above, and without limitation, the first time operation 714 is reached, it attempts to match the message 220 that contains the attribute “Partner=Fabrikam” with the entities in the entity store 210. Using the same operations explained with respect to FIG. 5 and FIG. 6, this results in two matching entities: entity 810 and entity 830. Both of these entities have a correlator with the “Partner” name, and both entities have the same value for this name: “Fabrikam”.

In at least one implementation of operation 715, any matching entities found by operation 714 are added to a list or some other data structure that maintains a set of new items to match. In the current example, both entity 810 and entity 830 are added to this list.

In at least one implementation, operational flow proceeds from operation 715 to operation 712, introduced and described above. At the current state of the example introduced above, there are no additional items to match to be examined for possible matches. There are new matching entities that have been found by operation 714, and added to a list of new items by operation 715, but the original item to match has been examined, so the example operational flow now proceeds to operation 716.

In one implementation of operation 716, the matching module 260 determines if the desired data has been found. In at least one implementation, it does this by examining the attributes of all of the items in the list of new items. If the desired data has been found (“Yes” branch, operation 716), the operational flow 700 proceeds to operation 718. If the desired data has not been found (“No” branch, operation 716), the operational flow 700 proceeds to operation 720.

In the current example, the attributes of the new matches are “Partner=Fabrikam”, “DocType=PO”, and “Partner No.=99”. None of these attributes has the name of the desired data, “Email”, and so the desired data has not been found, and the example operational flow 700 proceeds to operation 720.

In at least one implementation of operation 720, the operational flow 700 branches depending on whether any new matches were found in the most recent iteration or iterations of operation 714. In at least one implementation, it does this by examining the list of new items created during execution of operation 715. If the list contains any items, then new matches were found, and the operational flow proceeds to operation 724 (“Yes” branch, block 720). If the list does not contain any new items, the operational flow 700 proceeds to operation 722 (“No” branch, block 720).

If all of the possible matches for the initial item to match provided in operation 710 have been found and examined for the desired data, and yet the data has not been found, in at least one implementation of operation 722, the returning module 270 returns that no matching data was found.

However, in the current example introduced above, the list of new items contains two entities found while executing operation 714. Therefore, the example operational flow proceeds to operation 724.

In at least one implementation of operation 724, the items in the list of new items are now made the items to match, and then the list of new items is emptied so that the list of new items is ready to hold any new items found in subsequent matching operations. This prepares the operational flow 700 for the next round of matching that begins when the operational flow reaches operation 712. This next round of matching uses the matching entities found in this round. At this operation in the current example, the list of new items contains entity 810 and entity 830, so the execution of operation 724 results in the list of items to match now containing entity 810 and entity 830.

The exemplary operational flow 700 then proceeds to operation 712, which was introduced and described above. In this iteration, the list of items to match contains entity 810 and entity 830, which are each examined by the execution of operations 713, 714, and 715. Suppose that entity 830 is chosen first in operation 713. In one implementation, matching entity 830 against the entities in the entity store 210 results in a single match, with entity 840. This occurs because entity 830 and entity 840 have a correlator in common—“Partner No.”—and so the operational flow 600 compares the values for this name and finds a match (as they both contain the value “99”).

Note that in this implementation and example, but without limitation, the item to match is an entity, and so has at least one correlator, which results in operation 620 of FIG. 6 being executed, which results in a comparison of correlators rather than initially examining the names on the item to match.

If the desired data has been found, as determined by operation 716, in one implementation the exemplary operational flow 700 proceeds to operation 718 where, again in at least one implementation, the returning module 270 returns the desired data. It may do this by providing a simple name/value pair or set of name/value pairs, or it might return the data in some other form. For example, the exemplary operational flow 700 might return the entity or entities on which the desired data was found.

In some cases, the exemplary operational flow 700 may find multiple instances of the desired name or names. For example, it might find multiple instances of the name “Email”, each with a different value. In this case, operation 718 may return all of the name/value pairs and leave it up to the application using the results to determine how to resolve or use the data. In one or more other implementations, operation 718 may use rules or some other mechanism to determine which of the name/value pairs to return.

Continuing the example introduced above, when operation 716 is executed again, the desired data is found in the attribute “Email=John@Fabrikam.com”, and so the example operational flow 700 proceeds to operation 718, where the desired data is returned to the calling application.

Turning now to FIG. 8, shown therein are a number of exemplary entities 300. These exemplary entities are provided to assist in demonstrating how the operational flows described herein operate with actual data. This description of FIG. 8 is made with reference to the exemplary system 200 of FIG. 2 and is referenced by the discussions of FIG. 3, FIG. 4, FIG. 5, FIG. 6, and FIG. 7. However, it should be understood that the contents of FIG. 8 are not intended to be limited to being associated with any of FIG. 2, FIG. 3, FIG. 4, FIG. 5, FIG. 6, or FIG. 7. Furthermore, the specific contents of the exemplary entities in FIG. 8 do not in any way limit or imply a particular structure or use for entities. As described herein, entities are general data structures that can contain a wide variety of data.

As shown, the exemplary entities contain one or more correlators and one or more attributes. For example, entity 810 contains two attributes: “Partner=Fabrikam” and “DocType=PO”. Entity 810 also contains two correlators: “Partner” and “Partner+DocType”.

Some entities shown in FIG. 8 are part of an inheritance hierarchy. These entities are entity 810, entity 812, entity 814, entity 816, and entity 818. As shown by the lines that join these entities, entity 812, entity 814, and entity 816 are immediate children of entity 810, and entity 818 is an immediate child of entity 816.

In one or more implementations, this type of inheritance hierarchy implies that the attributes on a parent entity are also considered part of a child entity. In such an implementation, for example, and without limitation, the attributes associated with entity 812 comprise the “RMA No.=1234” attribute defined on entity 812 itself, as well as the “Partner=Fabrikam” and “DocType=PO” attributes defined on the parent entity 810.

Attributes defined on a child entity may, in some implementations, override the same attribute defined on a parent entity. For example, the “Location=Virginia” attribute on entity 818 overrides the “Location=US” attribute on its parent entity 816.

An overriding attribute can be of any type. For example, an overriding attribute may contain a value selected from a flat list, like the “Partner” attribute does in this example, or a value selected from a hierarchy, like the “Location” attribute. For example (not shown), if entity 816 contains the attribute “Partner=Lucern”—and “Lucern” and “Fabrikam” have no defined hierarchical relationship—the “Partner=Lucern” attribute overrides the “Partner=Fabrikam” attribute defined on entity 810.

In the same or different implementations, the matching system may use overridden attributes in different ways. For example, in some implementations, the presence of an attribute that overrides another attribute may completely hide the overridden attribute. In such implementations, the matching system may operate as if the attribute defined at the higher level does not exist and so may return matches based only on the overriding attribute defined at the lower level. Using the example above with “Fabrikam” and “Lucern”, only attributes of “Partner=Lucern” would match the child entity. In some other or the same implementations, the matching system may use both the overriding attribute and any overridden attributes. In an implementation like this, again using the above example, both the “Partner=Lucern” attribute and the “Partner=Fabrikam” attribute would match the child.

In some implementations, correlators are not inherited, so that, for example, entity 812 only has the single “Partner+DocType+RMA No.” correlator shown.

Finally, the location hierarchy 850 demonstrates one way in which attribute values themselves may be part of a hierarchy. In this example, an attribute named “Location” may have a value of “US”, “Virginia”, or “Washington”. In some implementations, the concept that a value, like “Virginia” or “Washington”, is more specific than another value, like “US”, can be used to differentiate between multiple matching entities, as explained above.

Although some particular implementations of systems and methods have been illustrated in the accompanying drawings and described in the foregoing Detailed Description, it will be understood that the systems and methods shown and described are not limited to the particular implementations described, but are capable of numerous rearrangements, modifications and substitutions without departing from the spirit set forth and defined by the following claims.

1. A method, comprising:
receiving an item to match, the item to match including at least one item attribute field, each item attribute field containing a name and a value; and
identifying one or more matching entities from a set of candidate entities, each candidate entity including at least one correlator field containing a correlator name that represents data that characterizes the entity, and at least one entity attribute field, each entity attribute field containing a name and a value.

2. The method of claim 1, wherein the one or more matching entities further comprise two or more matching entities; and the method further comprises identifying a best matching entity from the two or more matching entities.

3. The method of claim 1, wherein the one or more matching entities further comprise two or more matching entities, the method further comprising adding the two or more matching entities to a holding pond that includes entities being held for further manual review.

4. The method of claim 1, wherein the one or more matching entities further comprise two or more matching entities, the method further comprising adding the two or more matching entities to a holding pond that includes entities being held for further review by a computer-executable function.

5. The method of claim 1, wherein the identifying the one or more matching entities further comprises determining if a name associated with an item attribute field matches a name associated with a correlator field.

6. The method of claim 1, wherein the identifying the one or more matching entities further comprises determining if a value associated with an item attribute field matches a value associated with an entity attribute field.

7. The method of claim 1, wherein at least one of the entity attribute fields contains a value that is selected from a hierarchy of values.

8. The method of claim 1, wherein the item to match further comprises at least one item correlator field that contains an item correlator name that represents data that characterizes the item to match.

9. The method of claim 9, wherein the identifying one or more matching entities further comprises determining if one of the candidate entity correlator fields matches at least one of the item correlator fields.

10. The method of claim 1, wherein at least one of the one or more matching entities contains a task definition field identifying an executable task associated with the matching entity.

11. The method of claim 1, further comprising adding an additional correlator field to a candidate entity, such that a subsequent matching attempt may use the additional correlator field.

12. A method, comprising:
receiving an item, the item including at least one item attribute field, each item attribute field containing a name and a value; and
from a set of candidate entities, identifying one or more primary matching entities as being candidate entities that match the item, and identifying one or more secondary matching entities as being candidate entities that match a primary matching entity, wherein each entity includes at least one correlator field containing a correlator name that characterizes the entity, and at least one entity attribute field that contains a name and a value; and
returning one or more name/value pairs obtained from the primary and secondary matching entities.

13. The method of claim 12, wherein the number of secondary matching entities is zero.

14. The method of claim 12, wherein the identifying the one or more primary matching entities further comprises determining if a name associated with an item attribute field matches a name associated with a correlator field and determining if a value associated with an item attribute field matches a value associated with an entity attribute field.

15. The method of claim 12, wherein at least one of the entity attribute fields contains a value that is selected from a hierarchy of values.

16. The method of claim 12, wherein the item further comprises at least one item correlator field that contains an item correlator name that represents data that characterizes the item and wherein the identifying the one or more primary matching entities further comprises determining if one of the candidate entity correlator fields matches at least one of the item correlator fields.

17. The method of claim 12, further comprising adding an additional correlator field to a candidate entity, such that a subsequent matching attempt may use the additional correlator field.

18. A system, comprising: a receiving module configured to receive an item to match, the item to match including at least one item attribute field, each item attribute field containing a name and a value; and
a matching module configured to identify one or more matching entities from a set of candidate entities, each candidate entity including at least one correlator field containing a correlator name that represents data that characterizes the entity, and at least one entity attribute field, each entity attribute field containing a name and a value, by determining if a name associated with an item attribute field matches a name associated with a correlator field, and by determining if a value associated with an item attribute field matches a value associated with an entity attribute field.

19. The system of claim 18, further comprising:
a holding pond that includes entities being held for further manual review.

20. The system of claim 18, wherein at least one of the one or more matching entities contains a task definition field identifying an executable task associated with the matching entity.
